(19) United States
(12) Patent Application Publication
(10) Pub. No.: US 2010/0051699 A1
(43) Pub. Date: Mar. 4, 2010

(54) RFID TEXTILE LABEL

(76) Inventor: Francisco Speich, Gipf-Oberfrick (CH)

Correspondence Address: GEORGE PAPPAS, 919 S HARRISON STREET SUITE 300, FORT WAYNE, IN, 46802, US

(21) Appl. No.: 12/310,594

(22) PCT Filed: Sep. 11, 2007
(86) PCT No.: PCT/CH2007/000443

§ 371 Date: Feb. 27, 2009

(30) Foreign Application Priority Data
Sep. 18, 2006 (CH) 1476/06

(51) Int. Cl. G06K 19/07

(52) U.S. Cl. 235/492

(57) ABSTRACT

The invention relates to an RFID textile label, having an open antenna disposed on a carrier, wherein the antenna is connected to an RFID chip at the center region. In order to make the RFID textile label suitable both for long range and close range, the antenna comprises a loop in the center region, the RFID chip being connected either directly or indirectly to the shoulders of this loop, wherein the antenna loop equipped with the RFID chip serves as an H field antenna, and the antenna sections disposed outside of the antenna loop serve as an E field antenna.

This application claims priority of PCT application PCT/CH2007/000443 having a priority date of Sep. 18, 2006, the disclosure of which is incorporated herein by reference.

### TECHNICAL FIELD

The invention relates to an RFID textile label.

### BACKGROUND OF THE INVENTION

WO02/093524 A discloses an RFID textile label having an open antenna which is arranged on a carrier and is connected to an RFID chip. This antenna is in the form of a dipole antenna which is subdivided into two halves by the RFID chip and is used as an E-field antenna which is designed for an operating frequency in the UHF or microwave band. Together with the RFID chip, such E-field antennas form a transponder which is not suitable for short ranges.

U.S. 2006/0043198 A1 describes different ways of capacitively and inductively coupling an RFID chip to a dipole antenna (E-field antenna) and to a loop antenna (H-field antenna). These ways appear to be rather less suitable for use in textile labels.

### SUMMARY OF THE INVENTION

The object of the invention is to improve an RFID textile label of the type mentioned initially which is also suitable for short distances.

As a result of the fact that the antenna has a loop to whose sides the RFID chip is connected directly—by means of welding, soldering or adhesive bonding with an electrically conductive adhesive—or indirectly—by means of capacitive or inductive coupling, the antenna loop which is provided with the RFID chip being used as an H-field antenna and the antenna sections which are outside the antenna loop being used as an E-field antenna, an RFID textile label is provided which covers a long range of up to 10 meters, for example, by means of the E-field antenna and covers a close range of less than 1 meter, for example, by means of the H-field antenna.

The H-field antenna mainly responds to magnetic waves, for example, and the E-field antenna mainly responds to electrical waves. The magnetic waves are phase-shifted with respect to the electrical waves. In the case of an RFID textile label, the transponder composed of the RFID chip and the antenna is generally a passive transponder which becomes active only when H-waves or E-waves are applied to it. It obtains its electrical energy for reception and transmission from the electromagnetic waves which are also referred to as beams.

Permanently connecting the RFID chip to the sides of the antenna loop, provides a particularly simple solution.

However, it is also possible to arrange the RFID chip at the ends of a conductor loop on an auxiliary carrier, at least sections of said conductor loop running parallel to the antenna loop at a short distance from the latter and said conductor loop being inductively coupled to said antenna loop. It is also possible to arrange the RFID chip at the ends of a conductor loop on an auxiliary carrier, the conductor loop overlapping or crossing the antenna at at least two places and partially running parallel to the antenna at a distance from the latter and being inductively coupled to the antenna.

Another possibility is for the antenna loop to be separated from the rest of the antenna and to be connected to a further RFID chip.

The textile carrier is in the form of a textile sheet-like structure to which the antenna is fastened. For this purpose, the antenna may be applied to the textile sheet-like structure using a sewing or stitching method, or may be printed on in the form of an electrically conductive ink. However, it is more advantageous if the antenna is incorporated in the sheet-like structure, this being able to be effected, for example, by knitting it into knitwear. However, the embodiment according to which the textile sheet-like structure is a woven fabric, into which the antenna is woven during the production of the woven fabric on a weaving machine, is particularly advantageous.

If an auxiliary carrier is used when arranging the chip and the conductor loop, the auxiliary carrier may be composed of plastic.

The antenna may be formed from a metallic thread. However, it is also possible to form the antenna from a conductively coated polymer thread.

The abovementioned elements as well as those which are claimed and described in the following exemplary embodiments and are to be used according to the invention are not subject to any particular exceptions in terms of their size, shape, use of materials and their technical conception, with the result that the selection criteria known in the respective area of application can be used without restriction.

### BRIEF DESCRIPTION OF THE DRAWINGS

Further details, advantages and features of the subject matter of the present invention emerge from the following description of the associated drawings, in which:

FIG. 1 shows a plan view of a first RFID textile label having an antenna, which is laid in meandering fashion, and an RFID chip;

FIG. 2 shows the RFID textile label from FIG. 1 in the longitudinal section II-II shown in FIG. 1;

FIG. 3 shows a plan view of a second RFID textile label having an antenna, which is laid in meandering fashion, an RFID chip and a separated antenna loop which is connected to a further RFID chip;

FIG. 4 shows a plan view of a third RFID textile label having an RFID chip which is inductively connected to the one antenna loop; and

FIG. 5 shows the RFID textile label from FIG. 4 in the longitudinal section V-V shown in FIG. 4.

### DETAILED DESCRIPTION OF THE PREFERRED EMBODIMENTS

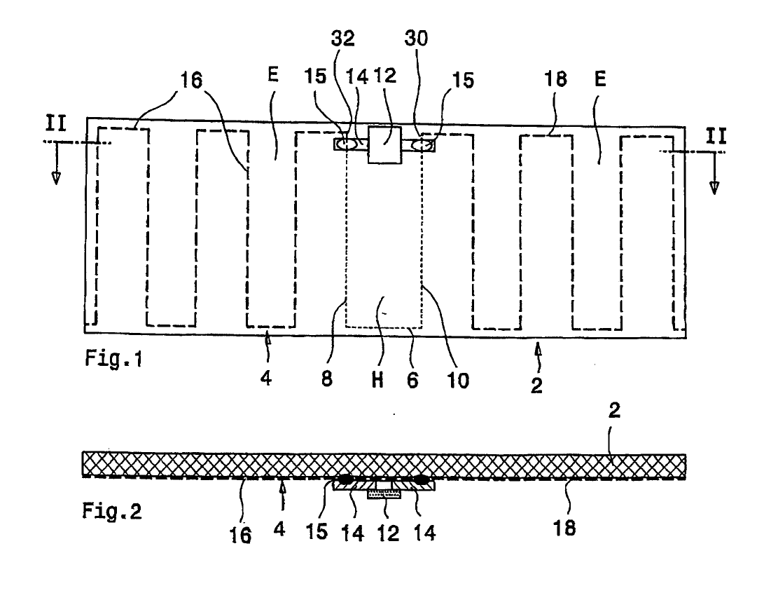

FIGS. 1 and 2 show a first exemplary embodiment of an RFID textile label having a textile carrier 2 made of a woven fabric into which an open antenna 4 is woven in meandering fashion. A loop 6 of the antenna, to the sides 8, 10 of which an RFID chip 12 is fastened by means of connection bases 14, is singled out in the central region, that is to say at half the length of the antenna. The connection bases 14 are connected 15 to the antenna 4 by means of welding, soldering or by means of an electrically conductive adhesive, for example. The antenna loop 6 forms an H-field antenna for close range and the antenna sections 16, 18 which are outside the antenna loop 6 are used as an E-field antenna for long range.

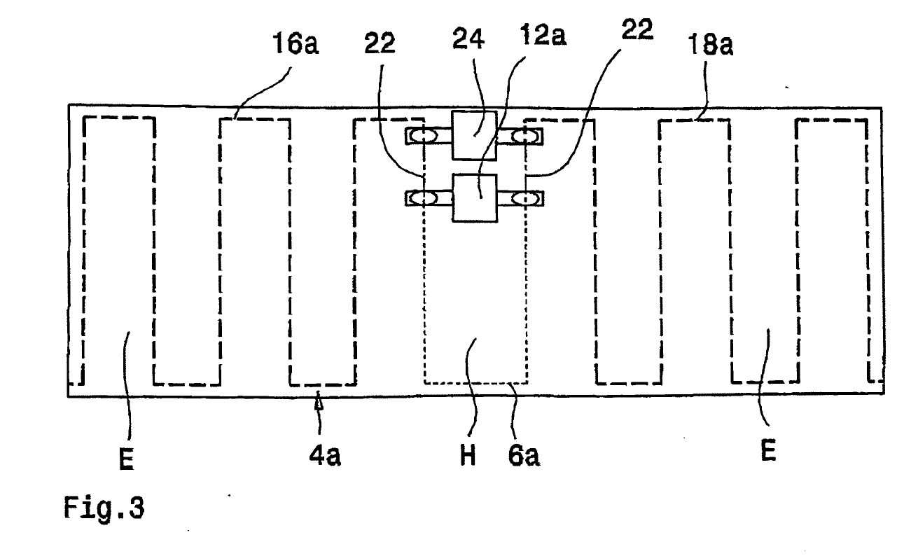

FIG. 3 shows a further RFID textile label which is constructed, in principle, like that in FIGS. 1 and 2 but the antenna loop 6a of the antenna 4a is separated from the antenna sections 16a, 18a by means of interruptions 20, 22. The RFID chip 24 is connected to the antenna sections 16a, 18a and covers the long range by means of the E-field. The ends of the antenna loop 6a are connected to an RFID chip 12a which responds to close range H.

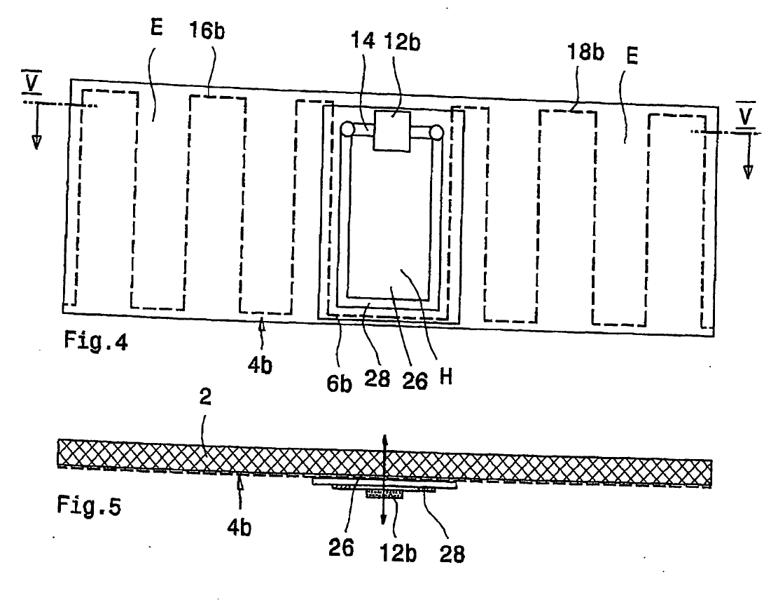

FIGS. 4 and 5 show a third RFID textile label which, like the previous examples, has a carrier 2 in which an antenna 4b is arranged in meandering fashion, said antenna in turn being subdivided into antenna sections 16b, 18b for long range E and a singled-out antenna loop 6b for close range H. In this example, the RFID chip 12b is not connected to the antenna 4b directly but rather indirectly in an inductive manner. For this purpose, the RFID chip 12b is arranged on an auxiliary carrier 26 which also has a conductor loop 28 which essentially runs parallel to the antenna loop 6b. The RFID chip 12b is connected at the ends 30, 32 of the conductor loop 28 by means of its connection bases 14. The auxiliary carrier which carries the RFID chip 12b is connected to the carrier 2, for example by means of adhesive bonding or a textile pocket which is woven onto the carrier 2, in such a manner that the conductor loop 28 is parallel to the antenna loop 6b and is at a short distance from the latter, with the result that the energy received by the antenna 4b is inductively transmitted to the conductor loop 28 and becomes effective in the RFID chip 12b. This applies both to the waves of the E-field and to those of the H-field.

As an alternative to the embodiment according to FIGS. 4 and 5, the conductor loop can overlap or cross the antenna loop at least twice and at least partially runs parallel to the antenna loop at a distance from the latter.

Waves, that is to say beams, which are at the same frequency or are at different frequencies and are in the range from 1 to 2500 MHz, for example, can be used for close range H and long range E. In the present invention, it is important that the antenna for close range H, which is less than 1 meter for example, essentially responds to the magnetic part of the waves. The antenna for long range E, which extends up to 10 meters for a passive transponder for example, essentially responds to the electrical part of the waves or beams which is phase-shifted with respect to the magnetic part.

### LIST OF REFERENCE SYMBOLS

2 Carrier

4 Antenna

4a Antenna

4b Antenna

6 Antenna loop

6a Antenna loop

6b Antenna loop

8 Side

10 Side

12 RFID chip

12a RFID chip

12b RFID chip

14 Connection base

15 Connection

16 Antenna section

16a Antenna section

16b Antenna section

18 Antenna section

18a Antenna section

18b Antenna section

20 Interruption

22 Interruption

24 RFID chip

26 Auxiliary carrier

28 Conductor loop

30 End

32 End

1. An RFID textile label having an open antenna which is incorporated in a textile carrier, the textile carrier being a woven fabric or a knitted fabric and the antenna being concomitantly woven in in meandering fashion during the production of the woven fabric on a weaving machine, the antenna being connected to an RFID chip in its central region, characterized in that the antenna has, in the central region, a loop to whose sides the RFID chip is connected, the antenna loop which is connected to the RFID chip being used as an H-field antenna and the antenna sections which are outside the antenna loop being used as an E-field antenna.

2. The RFID textile label as claimed in claim 1, characterized in that the RFID chip is permanently connected to the sides of the antenna loop by means of welding, soldering or adhesive bonding with an electrically conductive adhesive.

3. The RFID textile label as claimed in claim 1, characterized in that the RFID chip is arranged at the ends of a conductor loop on an auxiliary carrier having said conductor loop, and in that at least sections of the conductor loop run parallel to the antenna loop at a short distance from the latter and the conductor loop is inductively coupled to said antenna loop.

4. The RFID textile label as claimed in claim 1, characterized in that the RFID chip is arranged at the ends of a conductor loop on an auxiliary carrier having said conductor loop, and in that the conductor loop overlaps or crosses the antenna at at least two places and partially runs parallel to the antenna at a distance from the latter and the conductor loop and the antenna are inductively coupled to one another.

5. The RFID textile label as claimed in claim 1, characterized in that the antenna loop is separated from the rest of the antenna and is connected to a further RFID chip.

6. The RFID textile label as claimed in claim 3, characterized in that the auxiliary carrier is made of plastic.

7. The RFID textile label as claimed in claim 1, characterized in that the antenna has a metallic thread.

8. The RFID textile label as claimed in claim 1, characterized in that the antenna has a conductively coated polymer thread.

9. The RFID textile label as claimed in claim 2, characterized in that the antenna has a metallic thread.

10. The RFID textile label as claimed in claim 3, characterized in that the antenna has a metallic thread.

11. The RFID textile label as claimed in claim 4, characterized in that the antenna has a metallic thread.

12. The RFID textile label as claimed in claim 5, characterized in that the antenna has a metallic thread.

13. The RFID textile label as claimed in claim 6, characterized in that the antenna has a metallic thread.

14. The RFID textile label as claimed in claim 2, characterized in that the antenna has a conductively coated polymer thread.

15. The RFID textile label as claimed in claim 3, characterized in that the antenna has a conductively coated polymer thread.

16. The RFID textile label as claimed in claim 4, characterized in that the antenna has a conductively coated polymer thread.

17. The RFID textile label as claimed in claim 5, characterized in that the antenna has a conductively coated polymer thread.

18. The RFID textile label as claimed in claim 6, characterized in that the antenna has a conductively coated polymer thread.

19. The RFID textile label as claimed in claim 7, characterized in that the antenna has a conductively coated polymer thread.
